(19) United States
(12) Patent Application Publication
(10) Pub. No.: US 2005/0150343 A1
(43) Pub. Date: Jul. 14, 2005

(54) Device located on scrap shears or similar for reducing the frictional forces that occur as a result of the action of the material to be crushed on the closing motion

(76) Inventors: Thomas Deimel, Mulheim (DE); Sebastian Schipp, Coesfeld (DE); Karsten Rudolf Schneider, Velbert (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/499,860

(22) PCT Filed: Aug. 1, 2003
(86) PCT No.: PCT/DE03/02600

(30) Foreign Application Priority Data
Sep. 18, 2002 (DE) 102 43 125.6

(51) Int. Cl. B26D 1/30

(52) U.S. Cl. 83/607; 83/694; 83/829

(57) ABSTRACT

The invention relates to scrap shears (1) comprising several jaw arms (2a, 2b, 3), which can execute a pivoting motion in relation to one another in a closing or opening direction of the scrap shears. At least one jaw arm is equipped with a counter-bearing element (12) on the end section lying opposite the mounting (4), said element being displaced, (at least temporarily), in relation to the jaw arm carrying said element between a working position and a reduced friction position. The counter-bearing (12) is configured in such a way that the distance between its external surface (12b), which faces away from the carrying jaw arm and the mating surface (3b) of the neighbouring jaw arm (3), which faces towards said external surface, increases with the relative displacement of the counter-bearing element towards the reduced friction position.

The invention relates to a device on a scrap shear or the like for reducing friction created by material being cut encountered when cutting while closing in a direction, the device having several jaws that can pivot relative to each other on opening and closing of the scrap shear, an end section of the scrap shear remote from its mount having at least two adjacent jaw-carrying arms having blades that form a cutting region that is reduced on movement in the cutting direction, the arms of the end section laterally overlapping in a closed position of the scrap shear.

Scrap shears and similar cutting devices that are carried for example on a piece of hydraulic equipment serve for cutting and comminuting objects of steel or the like, in particular metal materials. The simplest systems are scrap shears with two relatively pivotal jaw-carrying arms having blades at their outer scrap-cutting ends; a cutting gap formed between them decreases as then approach each other. The invention is usable on all types of scrap shears and the like whether or not and how the jaw-carrying arms are pivoted into the open or closed position.

The scrap shear or the like can be set up such that only one of the arms or both arms are pivotal on the mount, with a single actuator for both arms or one for each arm. In addition the invention is usable with scrap shears or the like with more than two arms, in particular in an embodiment with two outer jaws carried on a double arm and a central jaw-carrying arm whose end moves on relative movement of the single and double arms between the outer jaws. The relative movement between the double-jaw arm and the central single-jaw arm can be effected by moving either the double arm or the central arm relative to the mount carrying the scrap shear. In embodiments with only one jaw arm movable relative to the mount the central arm is usually the movable one and the double-jaw arm is fixed to the mount. In order to prevent lateral deflection of the central jaw arm, the jaws of the double-jaw arm which define their side of the cutting gap support wear-resistant slide plates or a blade.

During a cutting operation transverse forces effective perpendicular to the plane of pivoting are created in the cutting region of the scrap shear by the material being cut and the gap in the cutting region between the acting jaw arms is increased so as to change the geometry of the cutting gap and allow the material being cut to get in between. If the transverse force is sufficiently high, the friction between the adjacent jaw arms is enough that it cannot be overcome by the drive forces for operating the scrap shear. The result is that the scrap shear is out of service and the jam must be cleared, a time-consuming and difficult job.

It is an object of the invention the make it possible to deal with jams occurring during cutting by special formation or manipulation of the parts of the scrap shear. The new apparatus should be particularly set up that the scrap shear is less sensitive to frictional forces and the forces to open it even under difficult circumstances are sufficient.

This object is achieved by the features of claim 1. The basic idea of the invention is that at least one jaw has an end section remote from the mount, may have a blade, and is provided with a support that is movable at least partially relative to the jaw between a work position and a pressure-reducing position and the support is constructed such that when moved in-to the friction-reducing position a spacing between its face turned away from an outer face supporting the jaw and the confronting face of the adjacent jaw increases. This is the same when the spacing between the moving outer face and a relatively fixed support face of the supporting arm decreases.

Under these circumstances the support element according to the invention can be constructed and mounted in many different ways. In particularly the support element can itself be a blade or can be provided with a blade. Furthermore according to the invention there can be a plurality of supports formed as blades themselves or as slide plates on adjacent jaw arms.

With regard to the basic object at least one of the existing supports is set up such that it operates either automatically (that is without external actuation) or can be operated when needed to move into the friction-reducing position. The term “use position” refers to the position of the active support during normal use of the scrap shear. Moving the support toward the friction-reducing position reduces the friction effective on the ends so that any jamming, for example at the start of opening the shear, is eliminated. By providing the scrap shear with at least one support which can be moved appropriately on the supporting jaw arm it is certain that the transverse forces effective in the cutting region and if necessary other frictional forces are reduced such that the scrap shear can be returned to service in short order.

The invention can be basically constituted such that the support can be freely shifted on the jaw arm in order to provide the necessary play. Alternatively in one embodiment the support includes at least one fastener for securing it to the supporting jaw (claim 2). This embodiments makes operation easy: Under normal conditions the support is secured by the fastener (for example at least one screw) to the carrying jaw arm in a predetermined position so it cannot move. In case during a cutting operation there is a jam, the fastener is released so that the support can move into the friction-reducing position. Once the jam is cleared, the support is moved back into the use position. The described embodiment is set up such that the support is only limitedly movable on the supporting jaw arm.

Independent of the actual working conditions and requirements, the invention can also be such that the fastener is remotely operable (claim 3). When the fastener is a clamping cylinder which normally fixes the support on the carrying jaw arm and if necessary, that is when actuated, lets the support move in the described manner. In the simplest system the clamping cylinder is hydraulic; alternatively other fasteners can be used, in particular motor-driven threaded spindles.

It is within the scope of the invention to make the support a wedge which can be shifted mainly in the opening direction of the scrap shear relative to the supporting jaw into the friction-reducing position (claim 4). This embodiment requires that the supporting arm have an appropriate guide face. It must be constructed to coact with the wedge such that movement of the wedge in the opening direction of the scrap shear increases the spacing between its outer face and the confronting face of the adjacent jaw arm. In the simplest case the wedge is braced such on the supporting jaw that the displaced wedge also moves transversely parallel to itself (claim 5).

In another embodiment of the invention the support is shiftable perpendicular to a pivot plane (claim 6). In a further development of this embodiment the support is shiftable and arrestable by threaded elements (claim 7). Alternatively the support can be formed as a cylinder unit and is operable by a pressurizable fluid (claim 8). The cylinder unit has a biasing unit that acts against the pressure of the fluid (claim 9). The biasing unit, in the simplest case a mechanical spring, can be set up that it is effective either toward the use portion or toward the friction-reducing position. Preferably the cylinder unit is displaced by the fluid into a use position in which the support assumes its use position.

In a further embodiment of the invention the support is pivotal relative to the supporting jaw such that in the friction-reducing position a spacing between the angled support outer face and a confronting face of the adjacent jaw seen in the closing direction of the scrap shear increases (claim 11). The support is pivoted either by a threaded element (claim 12) or by an eccentric (claim 13).

It is to be understood that in the scope of the teachings of the invention if necessary taking into account the actual structure of the scrap shear or similar cutting device, it is possible to use several of the above-described embodiments of the invention. This is in particular the case when the scrap shear or similar cutting device has more than two jaw-carrying arms, for example the above-described double arm and a central arm working with it.

The invention is more closely described in the following with reference to the drawing; therein there is only shown by way of example a scrap shear with three jaws, namely a double arm carrying two outer jaws and a central one-jaw-carrying arm pivotal between them. As already described, the invention can also be applied to other cutting devices, in particular scrap shears having only two jaws.

In particular:

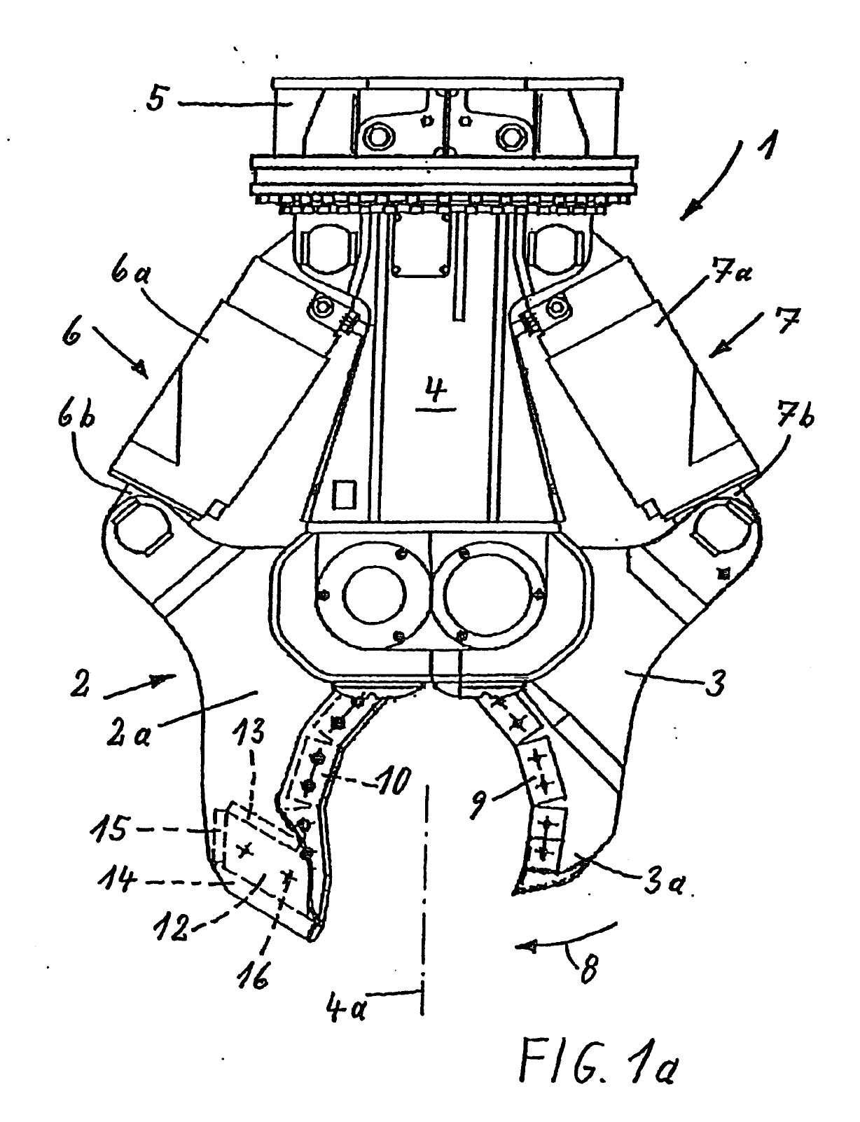

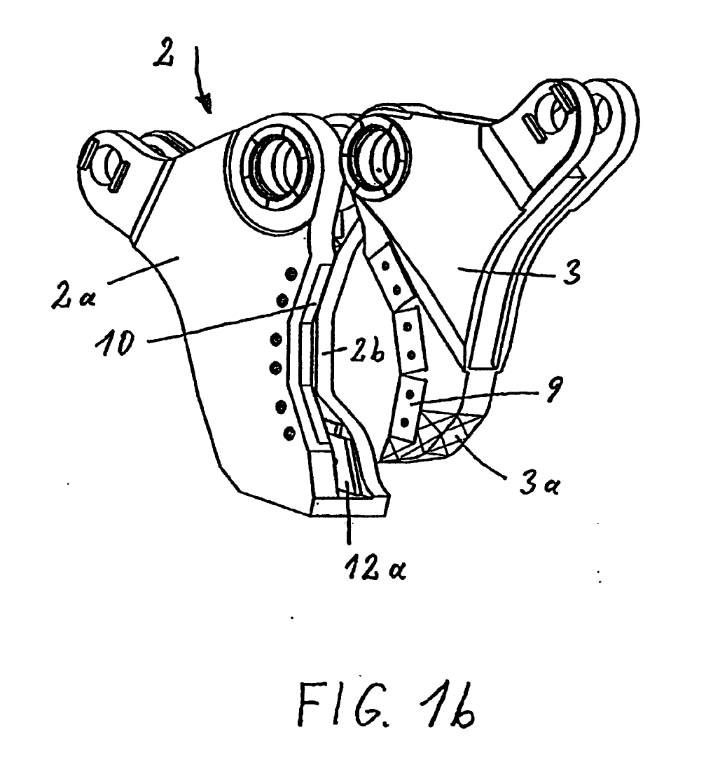

FIG. 1a is a schematic view of a scrap shear;

FIG. 1b is a perspective view of the double-jaw-carrying arm and the single-jaw-carrying arm of the scrap shear shown in FIG. 1a;

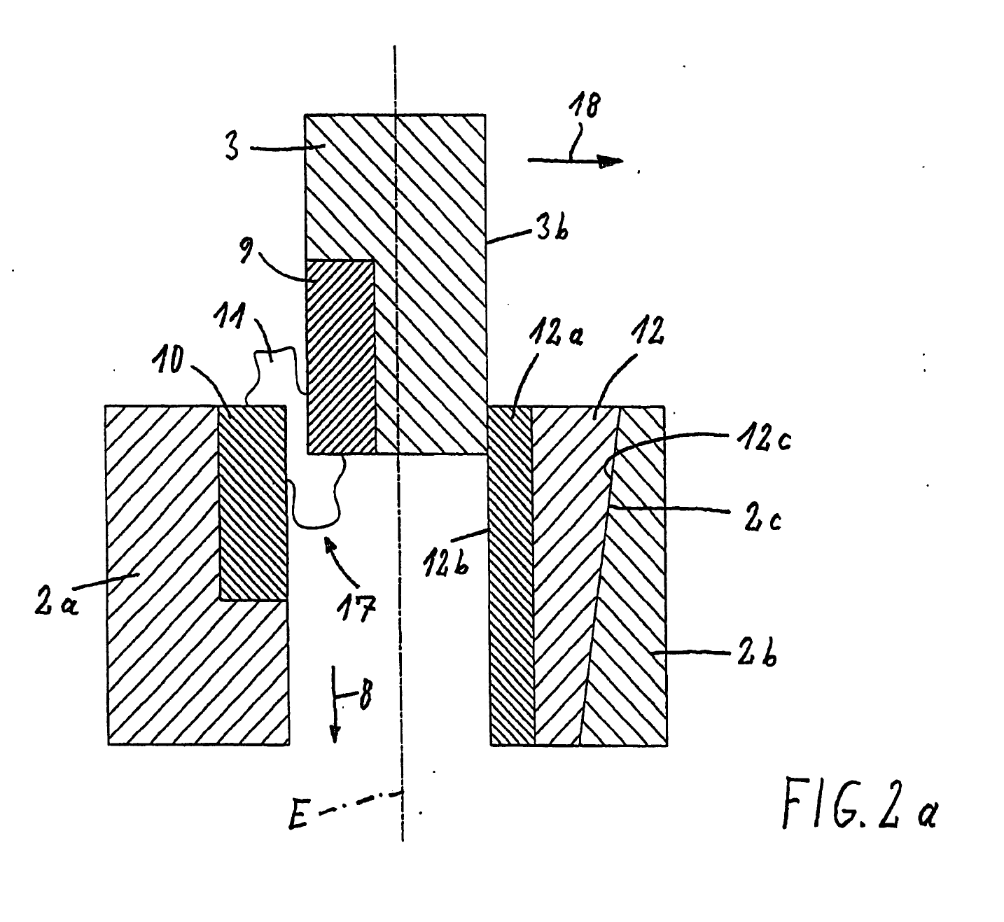

FIG. 2a is a largely schematic section through the double jaws and the central jaw of a scrap shear according to the invention shown during a cutting operation;

FIG. 2b is a section like FIG. 2a during opening of the shear;

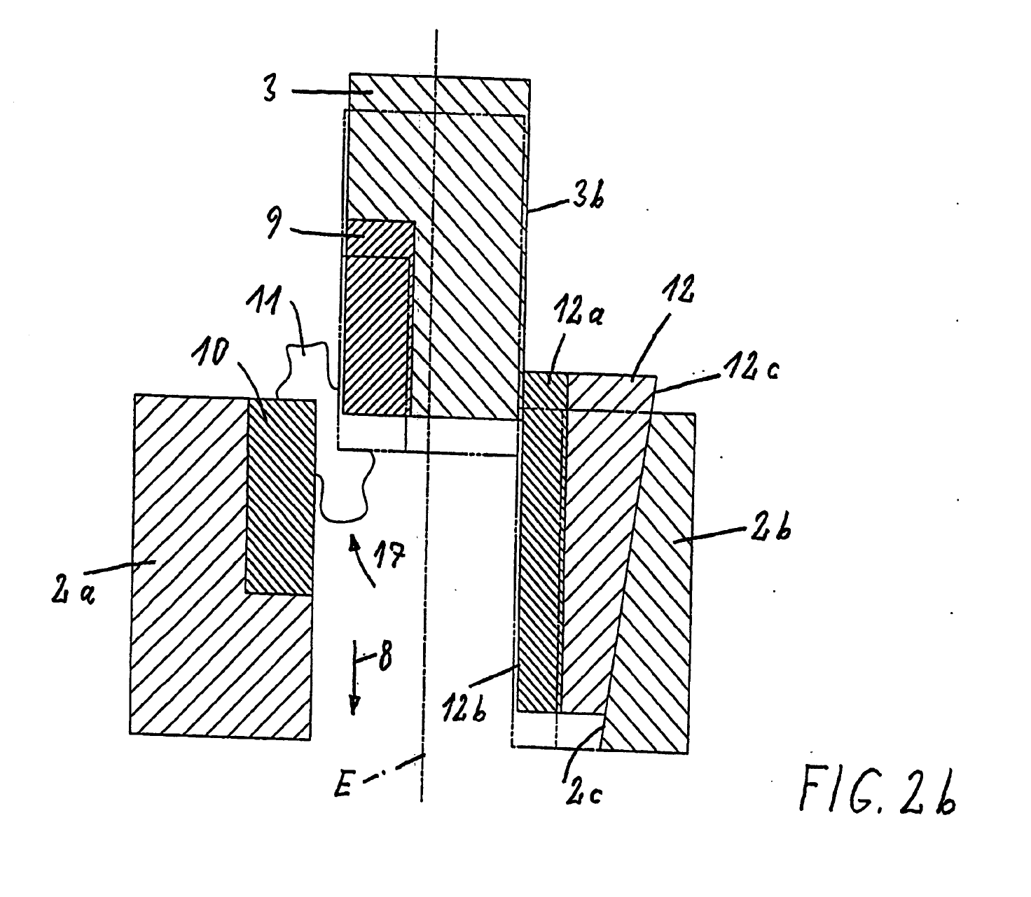

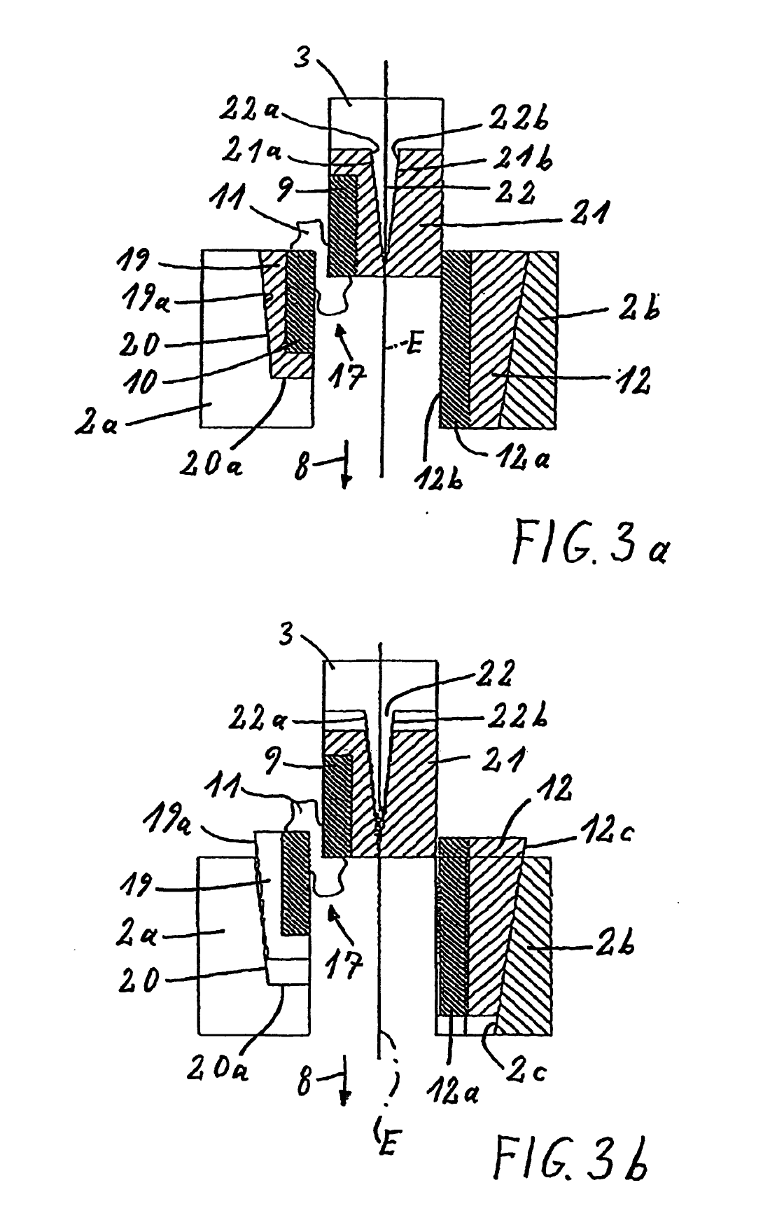

FIG. 3a is a largely schematic section through the double jaws and the central jaw of a scrap shear according to the invention during a cutting operation, where both of the double jaws and the central jaw are provided with wedges;

FIG. 3b is a section like FIG. 3a during opening of the shear;

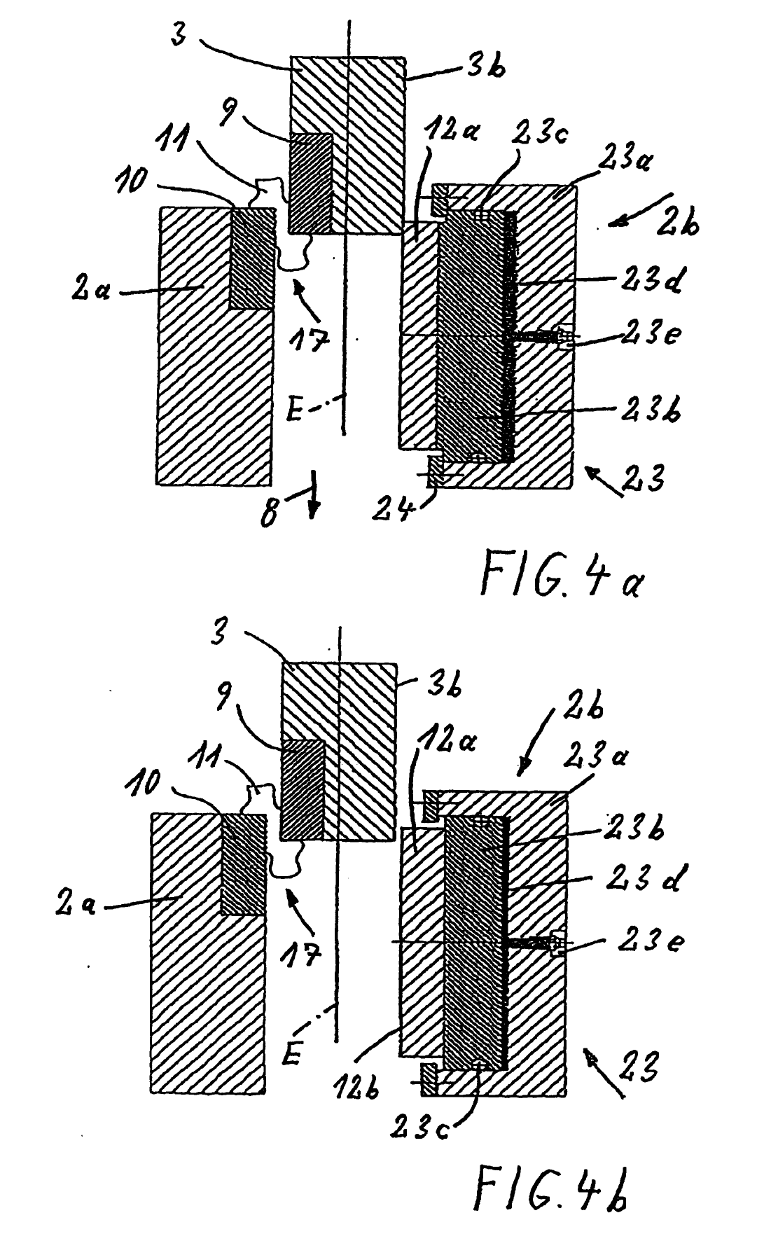

FIG. 4a is a largely schematic section through the double jaws and the central jaw of a scrap shear according to the invention during a cutting operation, where one of the double jaws has a cylinder unit as support;

FIG. 4b is a section like FIG. 4a during opening of the shear;

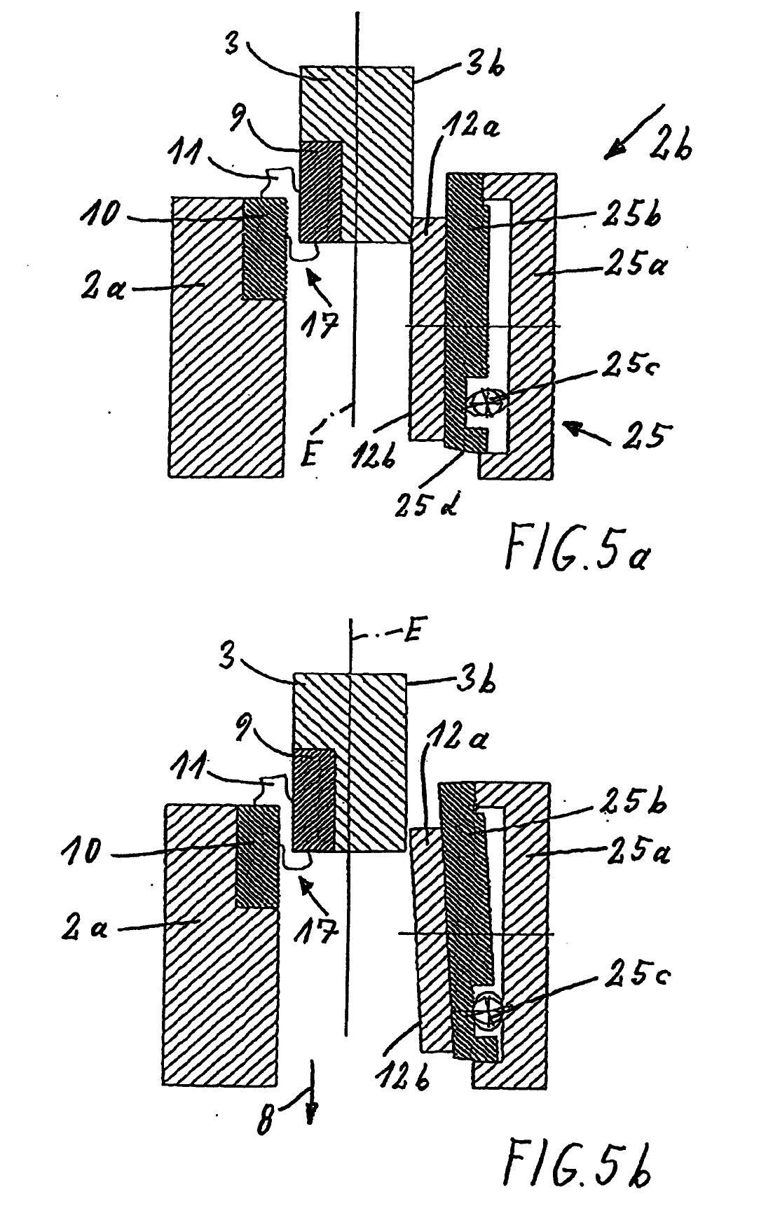

FIG. 5a is a largely schematic section through the double jaws and the central jaw of a scrap shear according to the invention during a cutting operation, where one of the double jaws has a support pivotal by an eccentric;

FIG. 5b is a section like FIG. 5a during opening of the shear;

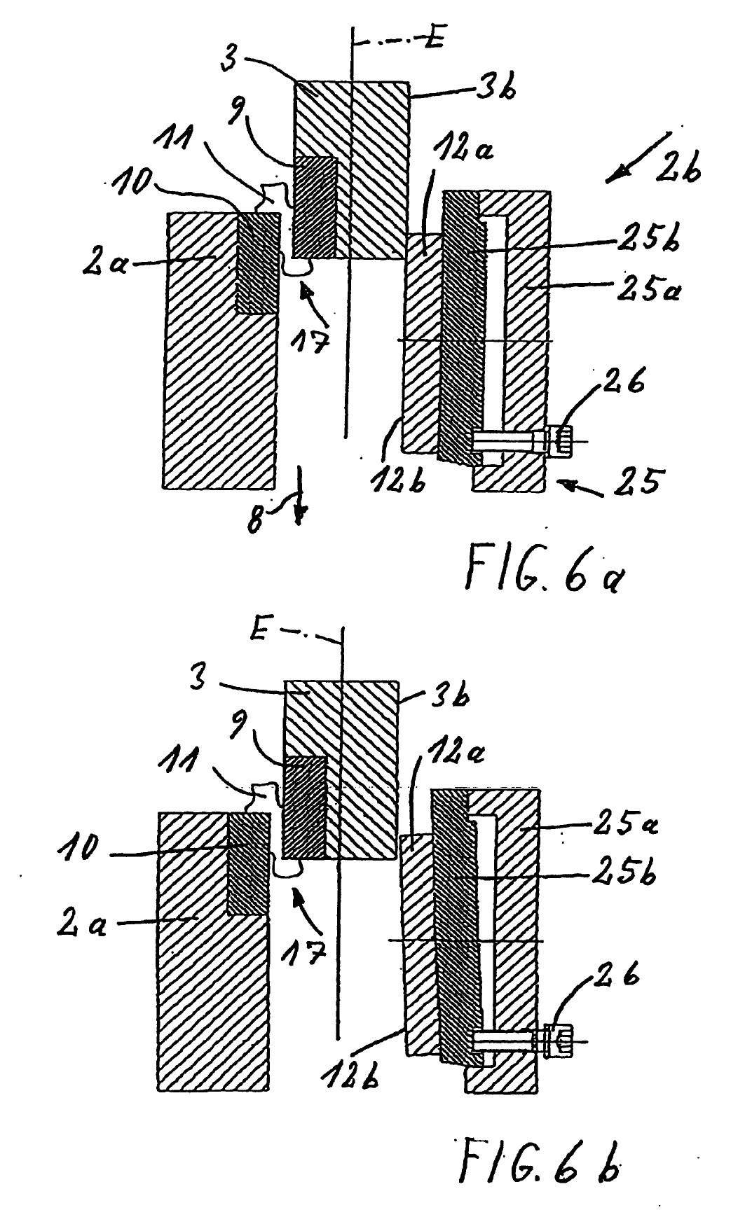

FIG. 6a is a largely schematic section through the double jaws and the central jaw of a scrap shear according to the invention during a cutting operation, where one of the double jaws has a support pivotal by a screw; and

FIG. 6b is a section like FIG. 6a during opening of the shear.

A hydraulic scrap shear 1 shown in FIG. 1a has as is known a double-jaw-carrying arm 2 and a central single-jaw-carrying arm 3 that are pivotal on a support 4. It in turn is hung on its side opposite the arms 2 and 3 on a rotary mount 5 by means it is connected pivotally to an unillustrated main support, for example a piece of hydraulic construction equipment. Whereas the central jaw-carrying arm 3 is single, the arm 2 is double, having as shown toward the front in FIG. 1a a forward first jaw 2a and, spaced therefrom, a second jaw 2b shown in the back in FIG. 1b.

In order to operate the main arms 2 and 3 there are two hydraulic actuators 6 and 7 having respective cylinders 6a and 7a pivoted on the bottom of the rotary mount 5 and piston rods 6b and 7b pivoted on the double arm 2 and the central single arm 3.

Extension of the hydraulic actuators 6 and 7 moves the main arms 2 and 3, which in turn are pivoted on the support 4, such that the shear 2 closes as shown by arrow 8. Shortening of the hydraulic cylinders 6 and 7 effects an opposite pivotal movement of the main arms 2 and 3 so that the shear 1 opens.

While the central arm 3 has on its outer edge shown in FIG. 1a three blades 9, the first jaw 2a has on its edge (see FIG. 1b) three longitudinally spaced blades 10, that is the blades 9 and 10 are removably mounted on confronting faces of the central jaw-carrying arm 3 and the first jaw 2a and form the cutting region of the shear 1 as it closes in the direction of the arrow 8. This is possible because the central arm 3 is shorter than the two jaws 2a and 2b of the double arm and is set up such that on closing its jaw 3a moves into the space between the jaws 2a and 2b; the ends of the adjacent arms similarly overlap, namely on the one hand the ends of the jaw 2a and the arm 3 and on the other hand the jaw 2b and the arm 3 are laterally adjacent each other on closing.

When, during closing in the direction of the arrow 8 (see FIG. 1a), the arms 2 and 3 are close enough together, the unillustrated material 11 being cut (see for example FIGS. 2a and 2b) is pressed by the jaw 3a against the double arm 2 and is cut through by the interaction of the respective blades 9 and 10, with the jaw 3a moving in between the jaws 2a and 2b. Since the central jaw-carrying arm 3 is subjected to transverse forces during the cutting operation, it is deflected (transversely) away from the jaw 2a and inevitably a portion of the cut material will get into the gap between the blades 9 and 10. The result of this is that the force that can be exerted by the hydraulic cylinders 6 and 7 is not enough to open the shear 1 in a direction opposite that of the arrow 8. The main arms 2 and 3 are thus wedged together as a result of friction at the gap between the central jaw-carrying arm 3 and the second jaw 2b and cannot be opened by operation of the hydraulic actuators 6 and 7, unless the system complies with the instant invention as described below.

As shown in FIGS. 1a, 1b, 2a, and 2b the scrap shear 1 according to the invention has an additional support element constituted as a wedge 12 to which a wear-resistant slide plate 12a is secured by unillustrated fasteners (for example screws). The wedge 12 is mounted, if necessary slidably, on the second jaw 2b level with the jaw 3a, more particularly on an inner face of the jaw 2b confronting the face of the central arm 3 opposite the face carrying the blades 9. As visible in FIG. 2a during a closing movement lateral deflection of the central jaw-carrying arm 3 is prevented in that its outer face 3b shown on the right slides on a confronting face 12b of the slide plate 12a. The slide plate 12a is retained on the second jaw 2b by guide plates 13 and 14 (see FIG. 1a) such that it assumes during a closing movement a position between the approaching double-jaw-carrying arm 2 and central arm 3 generally perpendicular to a longitudinal axis 4a of the holder 4. The extent of travel for the slide plate 12a and wedge 12 as shown on the left in FIG. 1a is set by a stop plate 15 fixed also on the second jaw 2b; in the FIG. 1a position the wedge 12 is braced laterally on the stop plate 15 and is fixed by screws 16 on the jaw 2b carrying the wedge 12. As described in more detail below, after loosening the screws, the slide plate 12a fixed on the wedge can move along the guide plates 13 and 14 relative to the second jaw 2b such that, starting from the use position shown for example in FIG. 2a, the distance between the slide plate 12a or its working face 12b from the first jaw 21 increases. This is possible because the wedge 12 is supported via a back face 12c on a complementary guide face 2c of the second jaw 2b; the two coacting faces 12c and 2c are (as shown in FIG. 2a) oriented such that they form seen in a direction opposite that of the arrow 8 an acute angle with the plane E in which the shear pivots. In any case the second jaw 2b and the wedge 12 are connected together, for example by screws and/or bolts, such that the wedge 12 can be allowed to move relative to the jaw 2b supporting it and can provide a small amount of play between the FIG. 2a position and a position (see FIG. 2b) in which friction is reduced.

FIG. 2a shows, after the cutting operation and the close-up position produced thereby, the position of the double-jaw-carrying arm 2 and the central single-jaw-carrying arm 3 with the material 11 in the gap 17 between the confronting blades 9 and 10 of the central arm 3 and the first jaw 2. The central arm 3 has been shifted laterally as shown by the arrow 18 as a result of the transverse forces in the cutting gap and bears with its face 3b the direction of arrow 18 on the face 12b of the slide plate 12a and via the wedge 12 on the second jaw 2b. The wedge is guided on the second jaw 2b such that the slide plate 12a and the wedge can only move parallel in the plane of the view, so that the spacing of the face 12b changes with respect to the first jaw 2a; the same is true for the spacing between the first jaw 2a and the central arm 3 so long as the same engages the slide plate 12a. In the working position of FIG. 2a the wedge 12 bears with its narrow end turned away from the arm 3 on the stop plate 15 (shown in FIG. 1a).

The friction created by the material 11 being cut in the cutting gap 17 and between the central arm 3 and the slide plate 12a leads in certain circumstances to a situation wherein the double arm 2 and the central arm 3 cannot be moved by the hydraulic actuators 6 and 7 and the shear 1 is jammed. In order to unjam it, one first loosens the screws 16 (shown in FIG. 1a) so that the slide plate 12a and the wedge 12 can slide on the second jaw 2b. The central arm 3 and the slide plate 12a are pressed solidly together, but now the forces tending to open the shear 1 do not have to overcome friction between the arm 3 and the slide plate 12a, but only have to overcome a lesser amount of friction between the faces 2c and 12c. In this case the applied forces are enough to shift the central arm 3 relative to the double arm 2, moving the slide plate 12a and the wedge 12 together with the central arm 3 and, as a result of the parallel shifting of the slide plate 12a relative to the second jaw 2b, the spacing between the slide plate 12a and the first jaw 2a increases. This increase in the gap has the result of reducing the forces jamming together the double arm 2 and the central arm 3 and thus unloads the entire system formed by the parts 2, 3, 12a, and 12. FIG. 2b shows this situation for the shear, after the screws 16 have been loosened the double arm 2 and the central arm 3 are moved in the opening direction (opposite arrow 8) and the slide plate 12a and the wedge 12 are moved along with the central arm 3 (that is upward in the drawing). In order to make these movements clear the working position (shown in FIG. 2a) of the parts 12 and 12a, which is the starting position of the central arm 3, is also shown in dot-dash lines.

The invention thus makes it possible to eliminate an occasional jam with relatively simple and inexpensive means. It is also within the scope of the invention to make the slide plate 12a and the wedge 12 a single part and thus form the face 12c directly on the slide plate 12a. In addition the central arm 3 can carry on its face turned toward the slide plate 12a a wear-resistant insert, in particularly a removable wear plate. Independently of this, it is advantageous according to the invention when the wedge 12 or a wedge-shaped slide plate 12a, is secured on the second jaw 2b, for example by means of a hydraulic cylinder, and is remotely controllable. The inventive solution also encompasses embodiments wherein the slide plate 12a and wedge 12 or the combined wedge and slide plate are not fixed but are right from the start mounted so they can move limitedly on the jaw 2b.

As shown in the embodiment of FIGS. 3a and 3b each jaw 2a, 2b, and 3 is provided with a support shaped as a wedge, the wedges being different and the second jaw 2b being the same as shown in FIGS. 2a and 2b. At least one of the blades 10 is removably mounted on a wedge 19 bearing via a face 19a on a complementary face 20a of the first jaw 2a. The extent of movement of the wedge 19 toward the supporting wedge 2a (that is downward in FIG. 3a) is set by a stop surface 20a. As already described, the wedge 19 can be constructed such that it can be clamped by unillustrated fasteners on the supporting jaw 2a in the use position (shown in FIG. 3a).

The central arm 3 is provided in the region that during cutting forms the cutting gap 17 with a wedge 21 that is slidable on the arm 3 and that if necessary also can be fixed by an unillustrated fastener. A cavity of the wedge 21 receives a wedge-shaped guide 22 of the central arm 3. In the use position shown in FIG. 3a the inwardly directed faces 21a and 21b sit on the complementary support faces 22a and 22b of the wedge-shaped guide 22. The latter is constructed such that it tapers in the direction of the arrow 8. The wedge 21 has on its face turned toward the jaw 2a at least one removably mounted blade 9.

FIG. 3b shows a situation of the shear wherein, if necessary after loosening any clamping, the jaws 2a and 2b on the one side the central arm 3 on the other are shifted relative to each other in the opening direction (against the arrow 8). Since as the opening movement of the shear takes place, the wedges 12, 19, and 21 shift both longitudinally and transversely relative to the supporting jaws 2b, 2a, and 3, the entire system (around the cutting gap) can be opened very quickly.

The embodiment of FIGS. 3a and 3b can also be varied within the scope of the invention in that only two of the three jaws 2a, 2b, and 3 are provided as shown with wedges, for example the outer jaws 2a and 2b of the double arm. Furthermore in order to clear jams it can be sufficient when only the central jaw is provided with the wedge 21. The first jaw 2a can be as shown in FIG. 2a; the second jaw 2b has no wedge 12 and is provided on its face turned toward the central arm 3 only with the slide plate 12a that is fixed by unillustrated fasteners on the second jaw.

Occasional jams can also be dealt with according to the invention in that at least one jaw of the shear is mounted on a support displaceable transversely to the closing plane. In the embodiment according to FIGS. 4a and 4b the second jaw 2b is provided on its face turned toward the central arm 3 with a transversely slidable support formed as a cylinder unit 23; it is comprised mainly of a housing 23a fixed on the second jaw 2b and a piston 23b movable in it in a seal 23c. The parts 23a to 23c define an internal compartment 23d that is pressurized with hydraulic fluid through a port 23e or if necessary depressurized. The stroke of the piston 23b in the housing 23a toward the central jaw-carrying arm 3 is limited by stops 24 fixed on the housing 23a. The piston 23b carries on its side turned away from the chamber 23d a slide plate 12a. As shown in particular in FIG. 4b, the cylinder unit 23 and the slide plate 12a are relatively oriented to each other such that the abutments 24 lie in every case outside the path of the central arm 3.

In the embodiment according to FIG. 4a the cylinder unit 23 is in its use position in which the piston 23b bears on the stops 24 and the central arm 3 bears via its face 3b on the face 12b of the slide plate 12a. The chamber 23d is pressurized with fluid. In contrast, FIG. 4b shows a condition in which the piston 23b has shifted inside the housing 23a (to the right in the drawing) so as to reduce friction, at the same time increasing the spacing for example between the face 12b and the first jaw 2a. This transverse shifting of the piston 23b is made possible and is in fact initiated by depressurization of the chamber 23d through the port 23e in that the central arm 3 as a result of the transverse forces effective in the cutting gap deflect it laterally and the slide plate 12a shifts with the depressurized piston 23b into the described position such that subassembly of the jaws 2a, 2b, and 3 and the cylinder unit 23 is unloaded in particular in the region of the cutting gap 17.

It is within the scope of the invention to modify the embodiment of FIGS. 4a and 4b such that the cylinder unit 23 on the second jaw 2b can also have a biasing unit effective on the piston 23b. This is effected as a mechanical spring support and is effective in that the depressurized piston 23b assumes inside the housing 23a the retracted friction-reducing position (shown to the right in the drawing). The use of a biasing unit can be advantageous in that it increases the deflection of the central arm 3 and thus helps unload the entire system in particular in the cutting gap 17.

It is to be understood that the cylinder unit in the solution according to the invention can also be double acting so that the piston 23 can be moved by appropriate pressurization into the FIG. 4a use position or the FIG. 4b pressure-reducing position.

This embodiment (according to FIGS. 4a and 4b) can also be made according to the invention in that the chamber 23d is connected via the port 23e to a press with a viscose agent (in particular lubricant grease) and in the event of a jam the port 23e is opened so that the viscose agent can be pushed out by the piston 23b. This embodiment has the advantage that it can be done with simple normally already provided drive units (for example a hand-operated lubricant gun), is not likely to fail, and is easy to use in case of a jam, for example by opening a valve that vents the port 23e and thus the chamber 23d.

The embodiment according to FIGS. 4a and 4b can also be simplified according to the invention in that the support is shifted by threaded elements but otherwise is fixed. This can be done in particular in that the piston 23b is shifted and fixed inside the housing 23d by unillustrated screws. The screws are threaded into the piston 23b and bear on the housing 23a so that the piston 23b is shifted according to the rotation direction of the screws either toward the use position (FIG. 4a) or toward the retracted friction-reducing position (FIG. 4b).

It is possible according to the invention to achieve the desired reduction of the friction created by the material being cut further by providing at least one of the jaw-carrying arms at its end remote from the mount with a support that is pivotal in a certain manner on the arm carrying it. In the embodiment according to FIGS. 5a and 5b the second jaw 2b carries a support 25 that is formed of the following parts: a U-section base plate 25a, a pivot plate 25b pivoted at one end on it, a slide plate 12a fixed on it, and an arrestable eccentric 25c that can pivot the pivot plate 25b relative to the base plate 25a. While an (unillustrated) pivot joint is provided between the parts 25a and 25b at the end of the base plate 25a closer to the central arm 3, the eccentric 25c is at the opposite end, the pivot plate 25b having an end face 25d engaging more or less into the base plate. FIG. 5a shows the pivot plate 25b when pressed by the arrestable eccentric 25c into the use position in which the face 12b of the slide plate 12a extends parallel to the pivot plane E or to the first jaw-2a.

Rotation of the eccentric 25c counterclockwise moves the pivot plate 25b bearing on the eccentric 25c such that the end face 25d moves back toward the base plate 25a and the pivot plate as well as the face 12d form an acute angle with the pivot plane E. Starting in the use position of FIG. 5a the pivot plate is moved by rotation of the eccentric 25c into the FIG. 5b into the friction-reducing position so that the gap between the face 12b and the first jaw 2a is increased and the cutting gap 17 is unloaded. It is understood that the slide plate 12a is mounted on the pivot plate 25b such that its pivoting on the base plate 25a in any case provides sufficient gap increase for the first jaw 2a. In addition the above-discussed embodiment is handy in that the pivot plate 25b can be set up such with respect to the eccentric 25c that the rotation is followed and the base plate 25a can be swung in either direction relative to the base plate 25a.

The embodiment of FIGS. 6a and 6b of the invention is different from that according to FIGS. 5a and 5b in that the angular position of the support 25 is effected by a threaded element comprises of at least one adjustment screw 26. Otherwise the pivotal support corresponds generally to the embodiment with the eccentric.

Starting in the use position (FIG. 6a) in which at least one adjustment screw 26 is at its maximum depth in the base plate 25a, the angle of the pivot plate 25b and the slide plate 12a to the pivot plane E is changed by turning of at least one of the adjustment screws 26 so as to move it steplessly outward into a friction-reducing position (FIG. 6b). The pivoting of the pivot plate 25b toward the friction-reducing position has the result that the spacing between the face 12b of the slide plate 12a and the first jaw 2a is increased. As a result the central arm 3 can deflect and reduce the pressure in the cutting gap 17 between the blades 9 and 10; this reduction entails a reduction in the friction resisting opening in the opening direction (against arrow 8) between the jaws 2a and 3 or 3 and 2b and thus makes further operation of the shear possible. As in the embodiment according to FIGS. 5a and 5b at least one of the adjustment screws 26 is connected with the pivot plate 25b so that this adjustment screw 26 can forcibly move the base plate 25b into the use position or into the friction-reducing position.

It is understood that the support 25 according to the invention can be provided with other adjustment elements. Furthermore it is possible according to the invention to operate the adjustment elements remotely by a motor and to lock them in the determined positions.

The advantage of the system of this invention is that equipping at least one arm of the scrap shear or a similar cutting apparatus with at least one movable support element makes it possible to reduce pressure in the entire system around the cutting gap that is caused by the material being cut. Similarly the one or more support elements are provided on the end of the arm remote from its support such that the distance to the adjacent arm can be made larger so that the face turned away form the arm of the support element moves relative to the supporting arm. A further advantage of the solution according to the invention is that an occasionally occurring jam can be cleared without dealing with the cutting region and without having to take apart and reassemble the arm structure.

1. A device on a scrap shear (1) or the like for reducing friction created by material (11) being cut encountered when cutting while closing in a direction (arrow 8), the device having several jaws (2a, 2b, 3) that can pivot relative to each other on opening and closing of the scrap shear (1), an end section of the scrap shear (1) remote from its mount (4) having at least two adjacent jaw-carrying arms (2a, 3; 3, 2b) having blades (9 and 10) that form a cutting region that is reduced on movement in the cutting direction (arrow 8), the arms (2a, 3, or 2b, 3) of the end section laterally overlapping in a closed position of the scrap shear (1),
characterized in that
at least one jaw (2a, 2b, 3) has an end section remote from the is mount (4), may have a blade (9 or 10), and is provided with a support (19, 12, or 21) which is movable at least partially relative to the jaw (2a, 2b, 3) between a work position and a pressure-reducing position and
the support is constructed such that when moved into the friction-reducing position a spacing between its face turned away from an outer face supporting the jaw (2a, 2b, 3) and the confronting face of the adjacent jaw increases.

2. The apparatus according to claim 1, characterized in that the support (12, 25) includes at least one fastener (16, 26) for securing it to the supporting jaw (2b).

3. The apparatus according to claim 2, characterized in that the fastener is remotely operable.

4. The apparatus according to one of the preceding claims, characterized in that the support is a wedge (12, 19, 21) which can be shifted mainly in the opening direction of the scrap shear (1) relative to the supporting jaw (2b, 2a, 3) into the friction-reducing position.

5. The apparatus according to claim 4, characterized in that the wedge (12, 29, 21) is braced such on the supporting jaw (2b, 2a, 3) that the displaced wedge also moves transversely parallel to itself.

6. The apparatus according to one of claims 1 to 3, characterized in that the support (23) is shiftable perpendicular to a pivot plane (E).

7. The apparatus according to claim 6, characterized in that the support is shiftable and arrestable by threaded elements.

8. The apparatus according to claim 6, characterized in that the support is formed as a cylinder unit (23) and is operable by a pressurizable fluid.

9. The apparatus according to claim 8, characterized in that the cylinder unit (23) has a biasing unit that acts against the pressure of the fluid.

10. The apparatus according to one of claims 8 and 9, characterized in that the cylinder unit (23) is displaced by the fluid into a use position in which the support assumes its use position.

11. The apparatus according to one of claims 1 to 3, characterized in that the support (25) is pivotal relative to the supporting jaw (2b) such that in the friction-reducing position a spacing between the angled support outer face (12b) and a confronting face (3b) of the adjacent jaw (3) seen in the closing direction (arrow 8) of the scrap shear (1) increases.

12. The apparatus according to claim 11, characterized in that the support (25) is pivoted by a threaded element (26).

13. The apparatus according to claim 11, characterized in that the support (25) is pivoted by an eccentric (25c).
